(19) United States
(12) Patent Application Publication
(10) Pub. No.: US 2007/0069004 A1
(43) Pub. Date: Mar. 29, 2007

(54) PRODUCT RECALL NOTIFICATION SYSTEM

(76) Inventor: Robert M. Adler, West Palm Beach, FL (US)

Correspondence Address: MCHALE & SLAVIN, P.A., 2855 PGA BLVD, PALM BEACH GARDENS, FL, 33410, US

(21) Appl. No.: 11/559,318

(22) Filed: Nov. 13, 2006

Related U.S. Application Data
(63) Continuation-in-part of application No. 11/414,899, filed on May 1, 2006.
Application No. 11/414,899 is a continuation-in-part of application No. 11/373,517, filed on Mar. 10, 2006.
Application No. 11/373,517 is a continuation-in-part of application No. 11/138,669, filed on May 25, 2005.

(51) Int. Cl. G06F 17/00

(52) U.S. Cl. 235/375

(57) ABSTRACT

A method of broadcasting product-recall advisory alerts via communications networks where a central notification computer is provided to broadcast advisory alerts to electronic device addresses stored in a subscriber database in a text, oral, pictorial, and computer retrievable format. The subscriber database contains subscriber data sets which each include the electronic device address, subscriber year of birth, and at least one geographic location associated with the electronic device address. When an advisory alert is initiated due to a product-recall, the affected subscribers are determined by geographic area, age, recreational activities, elderly parents, or other demographics is determined, and a geographic area defined by a perimeter is associated with the advisory alert. An algorithm retrieves addresses of the electronic devices associated with affected subscribers and the advisory alert is transmitted to the electronic device addresses.

### RELATED APPLICATIONS

This application is a continuation-in-part of U.S. patent application Ser. No. 11/414,899 filed May 1, 2006 which is a CIP of U.S. patent application Ser. No. 11/373,517 filed Mar. 10, 2006 which is a CIP of U.S. patent application Ser. No. 11/138,669 filed May 25, 2005, the contents of which are herein incorporated by reference.

### FIELD OF THE INVENTION

The invention relates to communication systems, and in particular to a system for broadcasting advisory alerts, on a subscriber basis, information regarding product recalls.

### BACKGROUND OF THE INVENTION

Product recalls are designed for the benefit and protection of the public consumer. A product recall typically is employed when a latent defect is discovered after shipment of product to the consumer. A product recall may be initiated voluntarily by a manufacturer, or involuntarily due to a government complaint. In some instances, a company discovers that one of its products is defective and recalls it entirely on its own. In the United States, the FDA is relied upon by the public to regulate food, drugs, medical devices, biologic, animal feed and drugs, cosmetics, radiation emitting products, as well as other products.

The U.S. Consumer Product Safety Commission is yet another government agency tasked with protecting the public from unreasonable risks of serious injury or death from more than 15,000 types of consumer products. The Product Safety Commission is committed to protecting consumers from products that pose a fire, electrical, chemical or mechanical hazard or that can injure children. The Product Safety Commission works to ensure the safety of products such as toys, cribs, power tools, cigarette lighters, and house hold chemicals.

The United States Department of Agriculture is yet another government agency tasked with protecting the public from agricultural related products. The National Highway Traffic Safety Administration is yet another government agency tasked with protecting the public from defective automobiles. Other agencies that provide valuable safety information is Environmental Protection Agency (e.g. notice of hazardous materials), the National Transportation Safety Board (e.g. notice of unsafe aircraft), the Coast Guard (e.g. regulation of boating products), Food Safety and Inspection Service (e.g. recall notification of beef products), Federal Citizen Information Center (e.g. recall notification of automotive, childrens' consumer, food, health, plant and animal products), and so forth. Individual States may have their own recall information, such as the Arkansas Attorney General under the Children's Product Safety Act of Arkansas (Act 1159 of House Bill 2330). Most states have similar protections, and the manufactures and distributors may each carry their own methods of notifying of product recall. The result is a dizzying amount of product recalls which has led the U.S. government to create another website (www.recalls.gov) in an effort to prevent confusion, yet such a website simply adds to the confusion by overwhelming the public with information.

For purposes of simplification, the following description is directed to the FDA as an entity that produces product recalls and describes their technique of notification. However, this invention is not limited to FDA recalls but rather has a polling technique to check what the individual consumer needs to make an informative decision.

While the recall of a defective or possibly harmful consumer product often is publicized by FDA alerts, in newspapers and on news broadcasts, the consuming public is so saturated with media hype that critical product recalls may go unnoticed, and localized product recalls may not be newsworthy. High priced items, such as a car, are tracked by use of warranty information. However, this is not the case in most consumer purchases that involve food, drugs, cosmetics, medical devices, and other products.

Further, many items may be manufactured in “lots” which are geographical in nature. For instance, drugs are manufactured in Lots and their shipment may be traced to a geographical area. The local pharmacies will try to call their customers but typically are ill equipped to track each customer and, in some instances, the ability to notify that a drug has been recalled can be life saving.

The Federal Food, Drug, and Cosmetic Act, does not generally authorize the FDA to “order” a manufacturer to recall a food, cosmetic or supplement. The agency may request a product recall if the firm is not willing to remove dangerous products from the market without FDA's written request.

Only when a medical device, human tissue products, and infant formula pose a risk to human health; the law specifically authorizes the FDA to prescribe a recall. It is the responsibility of the manufacturers and/or distributors of most products to carry out recalls of products regulated by FDA on a voluntary basis. In most instances, the FDA informs a company of findings that one of its products is defective and suggests or requests a recall. Usually, the company will comply. If the firm does not recall the product, then FDA can seek legal action under the FD&C Act which can be a time consuming process. Such actions may even include seizure of available product, and/or injunction of the firm, including a court request for recall of the product, during which time the public is exposed to the risk

While the FDA has proven to be a reliable method to remove potentially dangerous products from the market, the time it takes is unacceptable to those that are being harmed by the product. Further, FDA notification may consist of nothing more than a notification of the recall on the FDA website. If the media does not find such a recall to be newsworthy event, then the general public may not know about the product recall. For instance, most consumers would remember the lettuce recall that the FDA posted in October of 2006 but probably never heard of cole slaw, egg salad, macaroni slaw, carrot juice, turkey sandwiches, or milk allergen in quesadilla recall that occurred during the same month.

The FDA categorizes product-recalls into one of three classes according to the level of hazard involved. Class I recalls are for dangerous or defective products that could cause death or serious health problems. For example, botulism, label mix-up on a life saving drug, or a defective artificial heart valve. Class II recalls are for products that might cause a temporary health problem, or pose only a slight threat of a serious nature. An example may be the under dosing of a drug strength. Class III recalls are for products that are unlikely to cause any adverse health reaction, but that violate FDA labeling or manufacturing regulations.

A Class III defect may not be considered a newsworthy event until after someone in the public has been harmed. Even then, the news media may wait until many people are harmed to make public the problem, especially when there are other world events that are considered more important. However, harm to one's own child may not prove to be a newsworthy event but it is devastating to the parents of that child.

Even though the firm recalling the product may issue a press release, FDA seeks publicity about a recall only when it believes the public needs to be alerted about a serious hazard. For example, if a canned food product, purchased by a consumer at a retail store were found by FDA to contain botulinal toxin, an effort would be made to retrieve all the cans in circulation, including those in the hands of consumers. As part of this effort, the Agency also could issue a public warning via the news media to alert as many consumers as possible to the potential hazard. If the product recall concerned buttons on a teddy bear that might be swallowed by a young child, such a product recall may consist of an obscure website posting. The recall of 633 packages of Classic Oatmeal Cookies in November of 2006 by Archway Cookies concerned the lack of packaging details that the product may include the presence of an undeclared allergen, namely walnuts, because some of the consuming public is allergic to peanuts. FDA issues general information about new recalls it is monitoring through FDA Enforcement Reports, a weekly publication that is difficult for the average consumer to understand, much less access.

Inventions include methods of ensuring product tracking for purposes of recall. For instance, U.S. Pat. No. 6,859,672 discloses a method of linking a food source with a food product. This patent discloses the need for the linking of a source unit of food with the product items of food derived from the source units in order to assure food safety and assist in product recall when necessary. This is particularly directed to food poisoning caused by the presence of e. Coli bacteria in food product, bobine spongiform encephalopathy as well as other contaminations.

U.S. Pat. No. 6,611,806 discloses a computerized system for tracking the lot numbers for designated batches of pharmaceuticals which is necessary when a pharmaceutical is recalled by it's manufacturer or by the FDA. In this disclosure, the applicant recognizes the need for quick recall in instances where the recall may be caused by adverse effects or contamination such as a situation occurred when a blood containing hepatitis C was administered to approximately one million patients before a recall could be established.

Disclosures also exist for the methods of reaching a target audience over a network. U.S. Pat. No. 6,119,164 discloses a method and apparatus for distributing unsolicited information to a target audience without the use of a search engine with need to specify particular key words.

U.S. Pat. Nos. 6,401,095; 6,505,203; and 6,581,073, issued to the present inventor, are directed to systems which use an algorithm to send geographically targeted notices of an advisory event. These patents are directed to systems which utilize the Internet as an access point to provide information pertaining to missing persons, pet loss notification, or advisory alerts. The systems canvas specific geographic areas in a matter of seconds to aid in the location of a missing person or pet. The system utilizes an on-line enrollment form to distribute a photo of the lost person or pet via e-mail. Upon notification of a missing person or lost pet, the system initiates calculations, based upon the last known locations of the person or pet, to determine the most appropriate area for the search.

What is lacking in the art is a product recall notification system wherein a target audience is reached regarding product recalls.

### SUMMARY OF THE INVENTION

Disclosed is a Product Recall Notification System that is based on a central notification computer having a subscriber database including certain data sets such as a subscriber's geographical location, communication address (such as a cell phone number, e-mail address, PDA, cable or satellite coupling, etc. . . . ), date of birth, and other demographic information. The central notification computer is coupled to a communications network, and optionally, the global computer network.

The subscriber database in maintained in a computer retrievable format for access by the central notification computer. The central notification computer performs a polling of manufacturing and government databases posted on the global computer network to check for product-recalls. Once a product recall is uncovered, a product-recall age group affected by the product-recall is calculated and a list of subscribers potentially affected by the product-recall is compiled by comparing the type of recall to the demographics stored in the database. When the product recall is found to affect a subscriber, an advisory alert is created and the central notification computer initiates an advisory alert broadcast and transmits the advisory alert to the list of subscribers.

An objective of the invention is to provide a consumer advisory alert of product recall to subscribers via a communications network.

Another objective of the invention is to provide a consumer advisory alert that is sent through a global computer network to an electronic communication device accessible by the subscriber.

Still another objective of the invention is to provide a consumer advisory alert that associates a geographic area defined by a perimeter.

Yet another objective of the invention is to provide a consumer advisory alert that is automatically distributed by use of a distribution module executable at a notification computer.

Other objectives and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 schematically illustrates the elements and process of the advisory alert broadcast system of the invention;

FIG. 2 is an example of an advisory alert transmitted in text format for a Cookie Product Recall;

FIG. 2A is an example of an advisory alert transmitted in text format for a Generator Product Recall;

FIG. 3 is an example of an advisory alert transmitted in text format for a local neighborhood product recall for a trampoline;

FIG. 3A is an example of an advisory alert transmitted in text format for a local neighborhood product recall for Azathioprine tablets;

FIG. 4 illustrates the structure of the data sets in the subscriber database; and

FIG. 5 is an example of the system architecture.

### DETAILED DESCRIPTION OF THE INVENTION

Although the invention will be described in terms of a specific embodiment, it will be readily apparent to those skilled in this art that various modifications, rearrangements, and substitutions can be made without departing from the spirit of the invention.

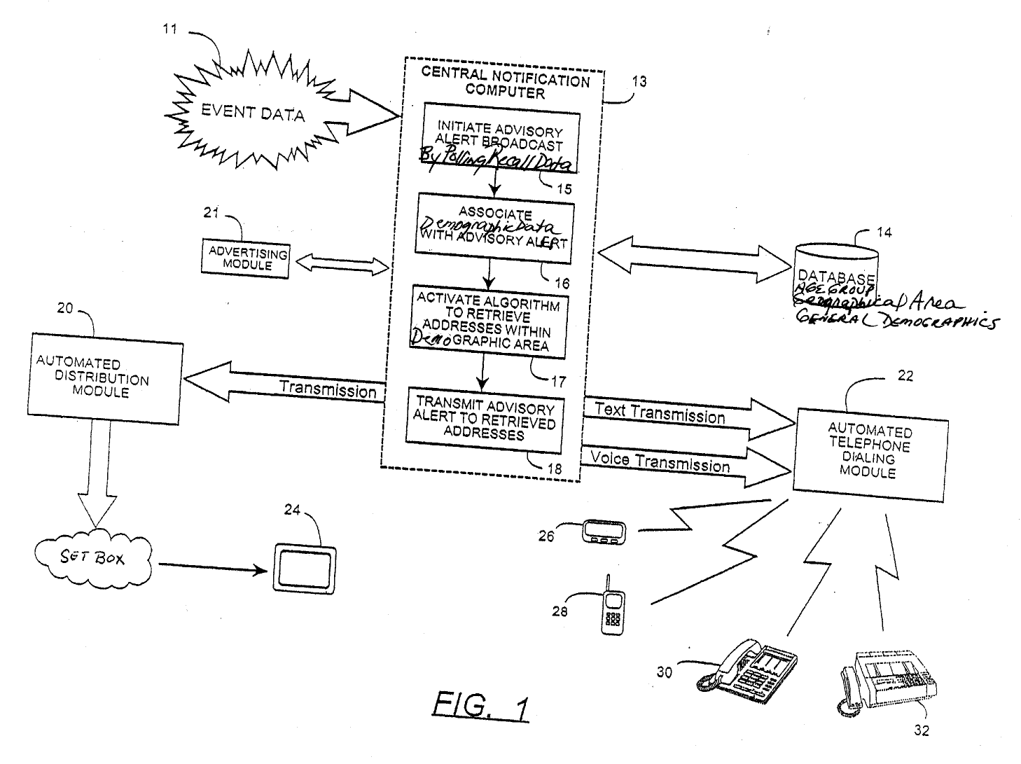

The present invention provides an advisory alert system which transmits text, pictorial and voice messages to electronic devices associated within a given geographic area. The structure of the overall system is schematically illustrated in FIG. 1. A central notification computer 13 is in communication with database 14 of subscribers which are to receive advisory alerts. The central notification computer 13 is shown as a single device for ease of description, however, the central notification computer 13 can be a plurality of computers in a hierarchal arrangement. The personal electronic devices which receive the advisory alerts can be any device which can be connected to a computer network or a telephone network. Suitable devices would include picture phones, personal computers, satellite phones, pagers, PDA devices, fax machines, satellite televisions, cable televisions, etc. The database 14 includes a plurality of subscriber data sets which include the address of the device (i.e. an email address or telephone number), the birth date of the subscriber, and at least one geographic location associated with the device. The subscriber database is in a computer retrievable format for access by the central notification computer.

An advisory alert is formed by first polling for product recalls. Preferably the polling is performed automatically by use of the notification computer accessing of the global computer network on a scheduled basis by searching websites, both government and private, for notice of a product recall. Optionally the notice can be polled by contact directly, e.g. by use of a telephone wherein the information is entered manually from a source when the recall is life threatening and use of a website recall could take to long. When a polling function locates a product recall, the product recall is compared against the subscriber data base to compile a list of subscribers affected by said product-recall. The advisory alert is formulated for the product-recall by first comparing age against the subscriber database, and then the geographical area. Once a list of affected subscribers is compiled, a product recall advisory is initiated (step 15) at the central notification computer 13. A geographic area having a defined perimeter is associated with the advisory alert (step 16) which is typically the general location which may be affected by the event 11. An algorithm is then activated (step 17) at the central notification computer 13 to retrieve the electronic device addresses for the subscribers associated with locations within the perimeter. In this embodiment, the advisory alert is then transmitted in both text, pictorial and voice format to the subscriber addresses.

For instance, toy chests were recalled by Delta Enterprise Corporation in November of 2006 due to red paint that contained lead. While the manufacturer is able to determine which store purchased the toys, the stores did not track the individual consumers. In such an instance, the subscriber list is compared for ages that may be affected and if they live in an area of a calculated radius to be affected. Thus, the product being recalled may be used by a nine year old in the West Palm Beach area. An advisory alert is sent to the parents of all children, ages six through twelve that reside within fifteen miles of the store that the product was purchased. Even if the parent did not purchase such a product, the parent would instruct the child not to play with a red toy at any of his friends homes. Such a targeted advisory alert assures that the product target audience is located thereby eliminating over saturating of the consumer with alerts, which typically results in lack of response.

As shown in FIG. 1, a text message may be sent to an automated email distribution module 20, which sends notifications to subscriber addresses with are associated with locations within the perimeter. The messages are received by the end users at, for example, personal computer 24 and PDA 34. An automated telephone dialing module 22 transmits the advisory alert in text, pictorial and voice format to devices such as pager 26, cellular telephone 28, land based telephone 30, and fax machine 32.

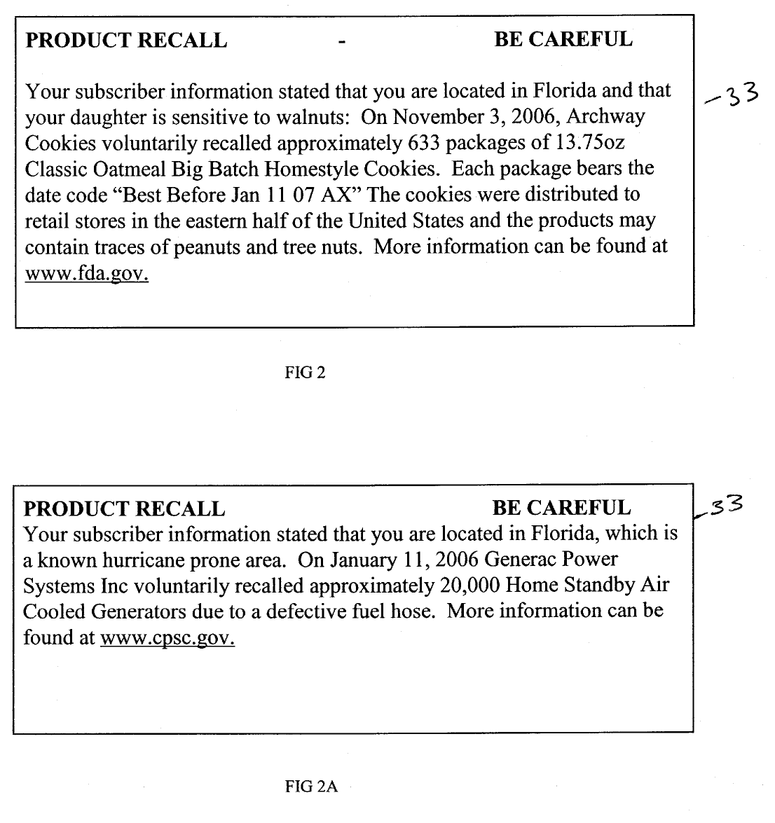

FIG. 2 illustrates an example of an advisory alert 33 for a hypothetical emergency product recall situation transmitted in text format. The information provided in the advisory alert 33 is geographically specific to the end user. In this example, the subscriber provided demographics that include information where they were located, Florida, and that they had a daughter who was sensitive to walnuts. The polling determined that on Nov. 3, 2006, Archway Cookies voluntarily recalled approximately 633 packages of 13.75 oz Classic Oatmeal Big Batch Homestyle Cookies. The cookies were distributed to retail stores in the eastern half of the United States and the products may contain traces of peanuts and tree nuts. The polled information was compared to the database and which revealed that this product recall would be of interest to this subscriber.

FIG. 2A provides an example wherein the subscriber provided geographic location and that they were home owners. A polling of product recalls revealed that approximately 20,000 Home Standby Air Cooled Generators were recalled due to a defective fuel hose. As the geographic location of the subscriber matched a recall that could affect the homeowner that lives in Florida, a known hurricane prone area where most home owners, or their neighbors, have generators.

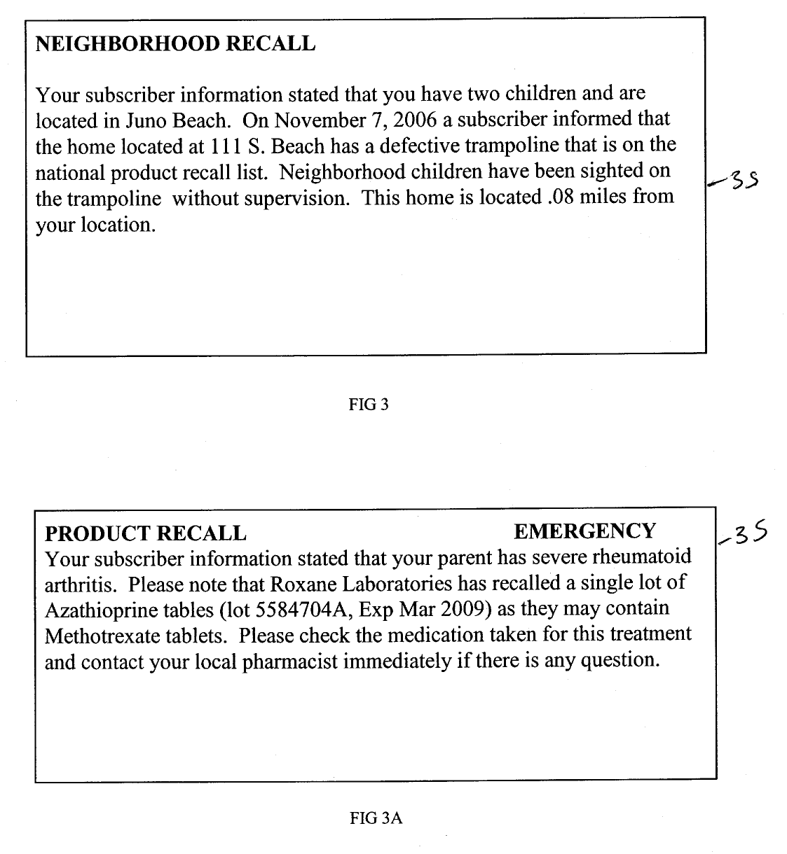

FIG. 3 sets forth an embodiment where the subscriber states that they have children and provides their home address. A fellow subscriber posts their own product recall stating that a home in Juno Beach is maintaining a trampoline that is recognized to be on the national product recall list, and that children have been sighted on the trampoline without supervision. This product recall is compared with subscribers within a geographical area, in this case two blocks, and subscribers are notified.

FIG. 3A sets forth an example wherein the subscriber information stated that a parent had severe rheumatoid arthritis. Polling of product recalls located a recall by Roxane Laboratories of a single lot of Azathioprine tables that inadvertently contained Methotrexate tablets.

In one aspect of the invention, product recall advisory alerts are disseminated based on information received from conventional sources, such as government-based EAS broadcasts, U.S. Consumer Product Safety Commission, FDA, commercial news organizations and wire services, law enforcement agency data, etc. In another aspect of the invention, event-related data can originate from “grass roots” sources so as to provide an on-line neighborhood product recall system. To implement such a system, an individual subscriber would have a means to provide event reports to a central monitoring station (with human operators) to receive reports which would correlate the information and then disseminate the appropriate advisory alerts through a central notification computer. As described above, the product recall advisory alerts are geographically specific and are sent only to subscribers that meet the relevant demographics, such as age, or that live in the relevant neighborhoods. The reports can include direct observations of dangerous products, such as swimming pools and trampolines that are unfenced and create attractive nuisance, pit bulls that are running free, water that is contaminated and a child may swim or drink the water, etc. An example of an advisory alert 44 which may be sent in an “neighborhood product recall” application of the invention is shown in FIG. 3. In this arrangement, the system of the invention provides nearly instantaneous transmission of relevant event data to the affected parties since the event data does not have to filter through the conventional news dissemination entities. The method of the invention can thus provide a neighborhood-based communication network which links the members of the community to one another and rapidly disseminates information vital for the safety of the community. This may include use of defective products that may be in use in the neighborhood. For instance, defective screen latches on swimming pool enclosures may affect a neighbor who does not participate in the subscriber based notification system. Thus a subscriber, whose children may frequent the neighbor's pool, may put his child on notice or even warn other parents of the potential problem.

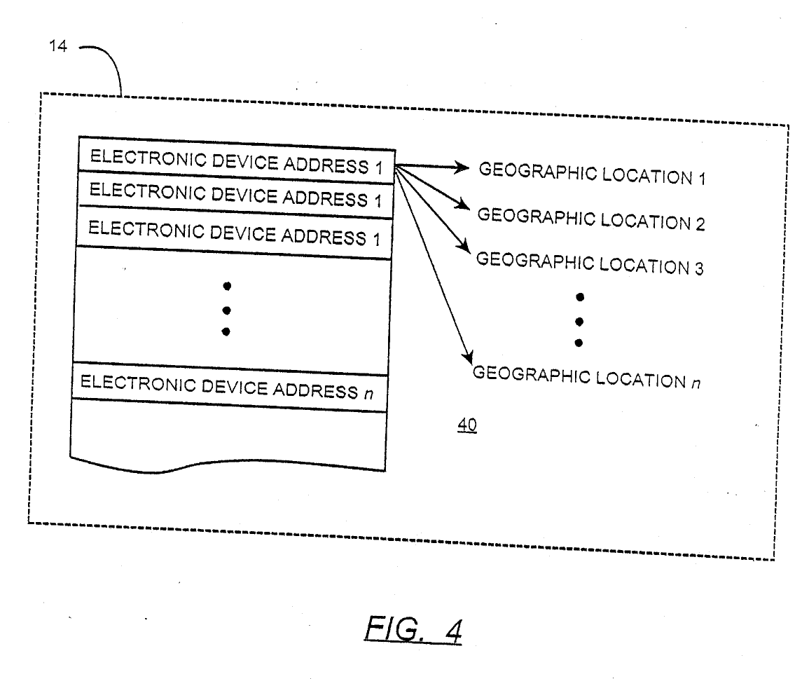

FIG. 4 illustrates an example of the data sets 40 stored in the subscriber database 14. As shown in FIG. 4, each electronic device address 41₁₋ₙ can be associated with a plurality of geographical locations 43₁₋ₙ in the subscriber database. The end user device need not be physically located in the geographical locations 43₁₋ₙ. A subscriber may wish to monitor events taking place in any number of geographic areas at once. For example, a subscriber address can be simultaneously associated with (1) the subscriber's home neighborhood, (2) the neighborhood of the subscriber's workplace, (3) the school attended by the subscriber's children, and (4) the neighborhood of a relative. In addition, it may be desired to provide temporary geographic associations for an individual subscriber. For example, a subscriber might be attending a large scale event (such as a meeting, festival, or other event) and would like to remain informed of a defective product which may be encountered in the immediate area for the duration of the event. In this scenario, the address of the subscriber would be associated with the event location only for the duration of the event.

Advisory alerts transmitted in accordance with the method of the invention will necessarily range from high level alert situations (Class I events as proposed by the FDA) to relatively low level alert situations (unfenced yards that have a swimming pool that is attractive to the neighborhood children). The advisory alerts can be graded, for example, on a numerical scale, to indicate the relative degree of danger to the recipient. In an alternative arrangement of the invention, a means is provided for a subscriber to select the lowest threshold level of advisory alert they wish to receive at a selected address. In this way, a subscriber can choose to receive higher alert advisories so that the subscriber is not inundated with low level alerts.

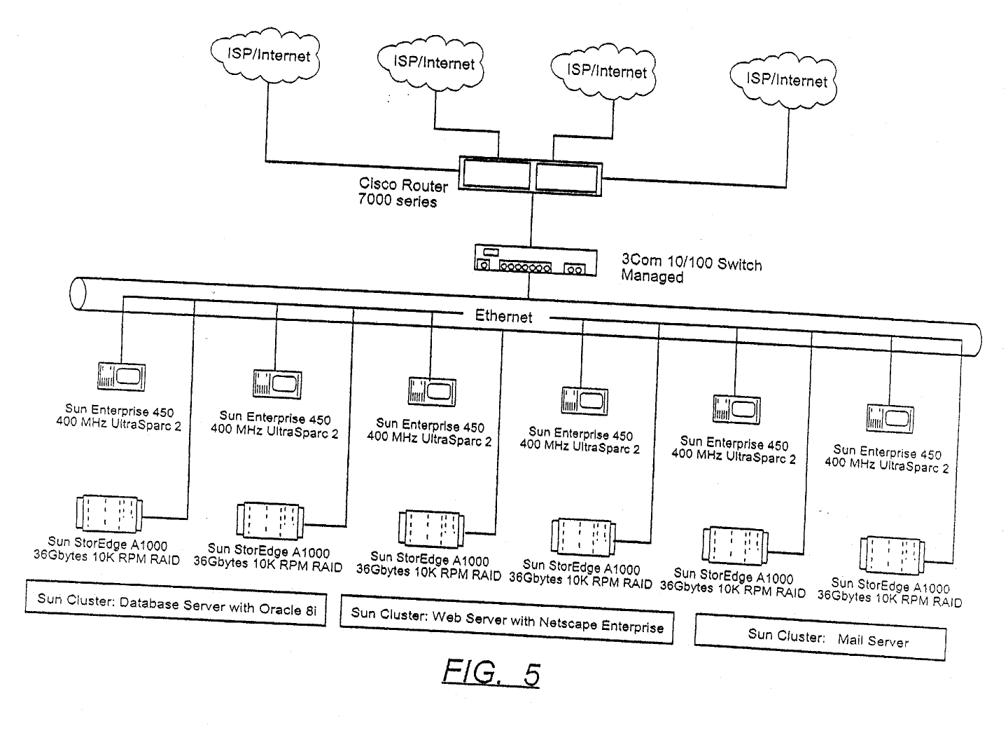

With reference to FIG. 5, a diagram exemplifying the system architecture is shown. The notification system will be divided into four main parts:

1) processing/database system;

2) messaging system;

3) web server; and

4) network/telecom infrastructure. All these parts are off-the-shelf items having the requisite functions. The particular manufacturer and Model is of no import but merely serves as an example.

The database server may rely on two SUN ENTERPRISE 450 servers or equivalents configured to operate as a cluster. ORACLE SERVER EE 8i, coupled with ORACLE PARALLEL SERVER or equivalents will optimize the SUN cluster architecture to provide an optimum database system. Data processing may be handled by ORACLE APPLICATION SERVER ENTERPRISE and ORACLE INTERMEDIA or equivalents.

The messaging system may be based upon a cluster architecture also and may utilize at least two SUN ENTERPRISE 2 Model 1400 servers to support SUN's SENDMAIL messaging server.

Using the same physical architecture as the messaging system, the web server may implement NETSCAPE ENTERPRISE SERVER.

The network/telecom may utilize a device having the capabilities of a CISCO 7500 Series router, particularly preferred is a CISCO 7576. Desirable characteristics are LAN/WAN services support, redundancy, reliability and performance. Scalability is accomplished due to a bandwidth extensible to 4 Gbps. Switching is accomplished via a 3COM SUPERSTACK II Switch 3300 or equivalent.

It is to be understood that while a certain form of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and drawings.

What is claimed is:

1. A Product Recall Notification System comprising: coupling a central notification computer to a communications network; creating a subscriber database on said central notification computer, said subscriber database including subscriber communication contact data address for at least one electronic communication device accessible by subscriber; maintaining the subscriber database in a computer retrievable format for access by the central notification computer; polling for a product-recall; compiling a list of subscribers affected by said product-recall and creating an advisory alert of a product-recall; providing a means to initiate an advisory alert broadcast from the central notification computer; and transmitting said advisory alert from said central notification computer to the subscriber's electronic communication device through said communications network.

2. The Product Recall Notification System according to claim 1 wherein said advisory alert is sent through said communications network to said electronic communication device accessible by the subscriber.

3. The Product Recall Notification System according to claim 1 including the step of associating a geographic area with said advisory alert, wherein the geographic area is defined by a perimeter.

4. The Product Recall Notification System according to claim 1 wherein the step of transmitting said advisory alert is an automated distribution module executable at the notification computer.

5. The Product Recall Notification System according to claim 1 wherein the communications network is a telephone network, and the electronic device addresses are telephone numbers.

6. The Product Recall Notification System according to claim 1, wherein the advisory alert is in text format; and the means to transmit an advisory alert to a plurality of electronic device addresses is an automated text messaging module executable at the notification computer.

7. The Product Recall Notification System according to claim 1, wherein the advisory alerts in text format are received by PDA's addressable via the electronic device address.

8. The Product Recall Notification System according to claim 1, wherein said product-recall is a drug.

9. The Product Recall Notification System according to claim 1, wherein the product-recall is food.

10. The Product Recall Notification System according to claim 1, wherein the product-recall is a consumer product.

11. The Product Recall Notification System according to claim 10, wherein said product-recall is a neighborhood product defect.

12. A Product Recall Notification System comprising:
coupling a central notification computer to a communications network and a global computer network; creating a subscriber database on said central notification computer, said subscriber database including a subscriber's date of birth and communication contact data address for at least one electronic communication device accessible by subscriber; maintaining the subscriber database in a computer retrievable format for access by the central notification computer; polling manufacturing and government databases placed on said global computer network for product-recalls; calculating a product-recall age group affected by said product-recalls and compiling a list of subscribers potentially affected by said product-recall; creating an advisory alert; providing a means to initiate an advisory alert broadcast from the central notification computer; and transmitting said advisory alert to said list of subscribers.

13. The Product Recall Notification System according to claim 12 wherein said advisory alert is sent through said communications network to said electronic communication device accessible by the subscriber.

14. The Product Recall Notification System according to claim 12 wherein said advisory alert is sent through said global computer network to said electronic communication device accessible by the subscriber.

15. The Product Recall Notification System according to claim 12 including the step of associating a geographic area with said advisory alert, wherein the geographic area is defined by a perimeter.

16. The Product Recall Notification System according to claim 12 wherein the step of transmitting said advisory alert is an automated distribution module executable at the notification computer.

17. The Product Recall Notification System according to claim 12 wherein the communications network is a telephone network, and the electronic device addresses are telephone numbers.

18. The Product Recall Notification System according to claim 12, wherein the advisory alert is in text format; and the means to transmit an advisory alert to a plurality of electronic device addresses is an automated text messaging module executable at the notification computer.

19. The Product Recall Notification System according to claim 12, wherein said product-recall is a drug.

20. The Product Recall Notification System according to claim 12, wherein the product-recall is food.

21. The Product Recall Notification System according to claim 12, wherein the product-recall is a consumer product.

22. The Product Recall Notification System according to claim 21, wherein said product-recall is a product defect located in a localized neighborhood.

23. The Product Recall Notification System according to claim 12, wherein the advisory alerts in text format are received by PDA's addressable via the electronic device address.

24. The Product Recall Notification System according to claim 12, wherein said subscriber list includes the subscriber' demographics.
